(19) United States
(12) Patent Application Publication
(10) Pub. No.: US 2026/0210630 A1
(43) Pub. Date: Jul. 23, 2026

(54) AN APPARATUS AND METHOD FOR PROVIDING A MATERIAL COMPRISING MOISTURE CONTENT TO BE DRIED

(71) Applicant: SPINNOVA OYJ, Jyväskylä (FI)

(72) Inventors: Arttu PELTONEN, Jyväskylä (FI); Pasi SELENIUS, Jyväskylä (FI); Niklas KNUUTILA, Jyväskylä (FI); Markku KATAJA, Jyväskylä (FI); Juha SALMELA, Jyväskylä (FI)

(21) Appl. No.: 19/140,545

(22) PCT Filed: Nov. 28, 2023
(86) PCT No.: PCT/FI2023/050653

§ 371 Date: Jun. 18, 2025

(30) Foreign Application Priority Data
Dec. 19, 2022 (FI) 20226118

(51) Int. Cl. F26B 25/22; D01D 10/06; D06H 3/08

(52) U.S. Cl. CPC F26B 25/22; D01D 10/06; D06H 3/08; D10B 2201/00

(57) ABSTRACT

An apparatus for providing a material comprising moisture content to be dried. The apparatus comprises at least a material provision unit a plurality of nozzles and a drying surface wherein said drying surface is configured to be movable with respect to the plurality of nozzles. The material provision unit is configured direct material comprising moisture content through the plurality of nozzles to the drying surface to obtain a plurality of elongated string-like material accumulations The apparatus additionally comprises at least one imaging device configured to obtain imaging data of at least one of the elongated string-like material accumulations and at least one control unit configured to determine at least one property of at least one of the elongated string-like material accumulations, wherein the control unit is additionally configured to facilitate performing of at least one action based on the determined property.

### TECHNICAL FIELD OF THE INVENTION

The invention relates to drying processes and apparatuses in general. More specifically, the invention relates to providing a material comprising moisture content to be dried, where imaging data is utilized to determine at least one property of the material comprising moisture content.

### BACKGROUND OF THE INVENTION

Many processes and apparatuses involving production of materials where a material is dried to produce a final product are susceptible to different types of malfunctions or flaws in the apparatus or in the manner that the process is carried out that may lead to varying problems in the process and/or in the quality of the produced dried material.

As new types of processes for material production are developed, it is also important to devise methods for management of malfunction situations associated with the machinery involved. In a related aspect, it is preferable to be aware of a quality of the produced material. Produced material may be inspected manually by humans, which is time-consuming, laborious, and involves high costs. Detection of malfunctioning or process-related flaws would also be beneficial at an earlier stage in the process, to avoid or at least reduce production of material of subpar quality.

Methods for production of materials which involve directing a material comprising moisture content through a plurality of nozzles to obtain a plurality of elongated string-like material accumulations that are then dried are known. More specifically, such methods may be utilized in production of filaments that may be further used e.g. to produce fabrics.

If malfunctioning of a part of involved machinery is detected, the material production process may be halted until the machinery is repaired to avoid production of poor-quality material. Stalling of the production process is however time-consuming and causes loss of revenue. If it is observed that a quality of produced material is not as desired and a flaw in the process or malfunctioning in machinery is determined, it may also be difficult to determine where in the process or machinery the fault has occurred. Discovery of the malfunctioning part of equipment may be laborious, and during this time the manufacturing process may remain stalled, which is undesirable.

### SUMMARY OF THE INVENTION

One purpose of the invention is to alleviate at least some of the problems in the prior art. In accordance with one aspect of the present invention, an apparatus for providing a material comprising moisture content to be dried is provided, the apparatus comprising at least:
a material provision unit,
a plurality of nozzles, and
a drying surface, wherein said drying surface is configured to be movable with respect to the plurality of nozzles,
wherein the material provision unit is configured to receive or provide a material comprising moisture content and direct the material comprising moisture content through the plurality of nozzles to the drying surface to obtain a plurality of elongated string-like material accumulations,
wherein the apparatus additionally comprises:
at least one imaging device configured to obtain imaging data of at least one of the elongated string-like material accumulations, and
at least one control unit configured to determine at least one property of at least one of the elongated string-like material accumulations based on said imaging data, wherein the control unit is additionally configured to facilitate performing of at least one action based on the determined property.

With the present invention, a material comprising moisture content may be dried or provided for drying, where at least one property relating to the material comprising moisture content may be determined in an automated fashion essentially without human input and on the fly, as the process is running, via obtaining imaging data regarding the plurality of elongated string-like material accumulations that are provided.

Human inspection of the material that is provided for drying or of the dried material may be reduced or avoided, which may lead to reduced requirements for human labor and a property may be determined faster and/or more efficiently than by a human operator.

The at least one property may be essentially continuously (referring also to occurring at predetermined time intervals) determined, evaluated, or monitored by obtaining a plurality of images (or the imaging data may be obtained essentially continuously or at predetermined time intervals), whereby the one or more actions may also be efficiently carried out on the fly as the process is running.

Imaging data and/or a determined property may be associated with a specific time or time interval. For instance, imaging data may be associated with a timestamp. Therefore, for example a change in determined property may be associated with a specific subprocess in the drying process based on correlating a time, time interval, or timestamp with the subprocess. It may then be determined which subprocess has resulted in the change of property.

With the present invention, the imaging-data based property determination may provide a way of obtaining information regarding a plurality of properties or characteristics relating to the drying process, the apparatus, and/or the material to be dried using only one inspection method. Obtaining such information with other methods than the imaging device may be much more complicated and e.g. require many sensors.

By obtaining the imaging data, it may be efficiently determined to which individual elongated string-like material accumulation and/or to which portion of elongated string-like material accumulations (relating to a specific set of nozzles, as will be discussed further below) the determined property is relating to. Therefore, characteristics of produced individual e.g. material strands, such as filaments, may be determined and/or characteristics of a specific portion of filaments, e.g. being produced by a specific set of nozzles, may be determined. The characteristic(s) that are determined may relate to a dried final product that is obtained by drying the material comprising moisture content. Additionally or alternatively, a characteristic or state relating to an individual nozzle that has produced a specific elongated string-like material accumulation and/or a certain set of nozzles and/or a certain nozzle in a set of nozzles may be determined.

Through the imaging means and obtained imaging data, a plurality of different types of properties may also be determined simultaneously. The properties may be indicative of a quality of the material that is to be manufactured by drying the material comprising moisture content and/or may be indicative of a quality or functioning parameter of the process for providing the (dried) manufactured material or providing the material comprising moisture content to be dried.

The control unit may be configured to facilitate an action that is related to an adjustment of at least one of providing a material comprising moisture content or of directing the material comprising moisture content through a plurality of nozzles to a drying surface, optionally to alter the determined property in a selected manner.

At least one selected action may be performed based on the at least one determined property, where the action may be an adjustment relating to the process of drying the material comprising moisture content or providing the material comprising moisture content to be dried, where there may not be a requirement for halting the entire process to determine what adjustment needs to be made and/or for making the adjustment.

In one embodiment, the apparatus may additionally comprise a mixing unit configured to receive at least one raw material component, optionally cellulose fibrils, and at least one solvent, optionally water, wherein the control unit may be configured to adjust a mixing parameter, such as a mixing speed, based on the determined property.

Embodiments of the apparatus may comprise at least one drying unit configured to provide drying energy, such as heat, to dry the material comprising moisture content.

In one embodiment, the control unit may be configured to determine at least one property that is indicative of at least one dimension of at least one of the elongated string-like material accumulations. By obtaining information regarding a dimension of the elongated string-like material accumulations, it may be possible to determine a uniformity of the material that shall be produced. The uniformity may be related to a quality of the material that shall be produced. If no material is being provided through a specific nozzle, the at least one dimension may be zero.

A property that is indicative of dimensions of at least one of the string-like material accumulations may imply that a certain string-like material accumulation is non-existent on the surface, which should be present on the surface as a nozzle is provided at a corresponding location in the apparatus. Here the dimension could thus be a width, which is determined to be zero or close to zero. This property may be obtained e.g. by determining a number of elongated string-like material accumulations that are present on a surface at a specific location. The number may be compared to a number of elongated string-like material accumulations that should be present on the surface at said location if all nozzles are functioning as they should. A property of an elongated string-like material accumulation relating to a blocked nozzle could be non-existence of the elongated string-like material accumulation.

The one or more properties may be determined based on imaging data regarding a separate elongated string-like material accumulation and/or based on imaging data regarding a set or portion of elongated string-like material accumulations, e.g. relating to a set of nozzles, as will be discussed further herein.

The property that is indicative of dimensions may also provide data regarding a continuity of the string-like material accumulation(s).

Based on one or more determined dimensions or one or more properties indicative of dimensions and/or a uniformity of one or more of the elongated string-like material accumulations, it may be determined that a dimension or uniformity relating to a selected elongated string-like material accumulation exceeds a predetermined maximum value or falls below a predetermined minimum value and/or that a property being indicative of at least one dimension indicates non-existence of at least one elongated string-like material accumulation. Thereafter, the at least one performed action may comprise determining that a nozzle associated with the selected elongated string-like material accumulation is at least partially blocked.

Upon determining that at least one nozzle is at least partially blocked, the control unit may be configured to facilitate an action comprising adjusting a mass flow rate or volume flow rate of the material comprising moisture content being provided to the plurality of nozzles via the material provision unit, preferably by reducing a mass flow rate or volume flow rate of the material comprising moisture content by a selected amount based on data indicating nozzles that are at least partially blocked to achieve or approach a reduced exit velocity of material from unblocked nozzles.

The material provision unit may in some embodiments of the invention be configured to provide the material comprising moisture content through at least one set of nozzles comprising a selected number of nozzles, with material comprising moisture content being provided to at least one set of a selected number of nozzles at selected mass flow rate or volume flow rate, and wherein the control unit may be configured to:
obtain or determine a reference exit velocity of material comprising moisture content from one nozzle of said at least one set of nozzles comprising a selected number of nozzles,
determine a number of nozzles in said at least one set of a selected number of nozzles that is at least partially blocked based on said imaging data, and
adjust a mass flow rate or volume flow rate of material comprising moisture content being provided to said at least one set of a selected number of nozzles to achieve or at least approach the reference exit velocity of material comprising moisture content from the remaining nozzles of the at least one set of a selected number of nozzles.

Considering a set of nozzles comprising a selected number of nozzles, if one nozzle of the set is at least partially blocked, the string-like material accumulations associated with unblocked nozzles of the set may comprise dimensions that are larger than threshold dimensions and/or may exhibit widening in dimensions. Here, a performed adjustment may lead to reduction in these dimensions, optionally to a reference value, such as a reference width.

An imaging device may comprise at least one optical instrument imaging device configured to obtain at least one image, optionally at least one camera, such as a photographic camera, a line scan camera, and/or a video camera.

As the imaging data may efficiently be used to determine which string-like material accumulation is affected and/or which specific nozzle is at least partially blocked or is otherwise malfunctioning, an adjustment may be made efficiently to compensate for the malfunctioning, so that the process may still be continued, the determined parameter may be adjusted in a selected manner, and/or a maintenance procedure may be efficiently facilitated relating to the specific nozzle that requires maintenance.

In some embodiments, the control unit may be configured to determine a plurality of different properties essentially simultaneously. One property may e.g. be related to a dimension of the elongated string-like material accumulation(s) and one other determined property may be indicative of a quality of the produced material, such as a property related to a color parameter. Thus e.g. a blockage of one or more nozzles may be detected essentially simultaneously to monitoring of quality of the produced material. Obtaining and analyzing imaging data may enable the simultaneous determination of a plurality of different types of properties.

The control unit may be configured to determine at least one quality parameter relating to the at least one elongated string-like material accumulation based on said at least one determined property and said at least one action may then comprise assigning at least a portion of the provided material comprising moisture content to be dried with at least one quality grade according to predetermined criteria. Based on a quality indicator, a selected portion of produced material may be discarded or e.g. used for a different purpose than produced material with different level of quality indicator.

The control unit may be configured to determine a property comprising a color parameter of the material comprising moisture content, or a homogeneity parameter of the material comprising moisture content, for instance. A color parameter may comprise a parameter relating to color intensity, which may be determined through color imaging data or black-and-white or gray-monochrome imaging data.

A method for providing a material comprising moisture content to be dried is also provided according to one aspect of the invention, the method comprising
providing a material comprising moisture content,
directing the material comprising moisture content through a plurality of nozzles to a drying surface, and moving said drying surface with respect to the plurality of nozzles to obtain a plurality of elongated string-like material accumulations,
obtaining imaging data relating to the plurality of elongated string-like material accumulations,
determining at least one property of at least one of the elongated string-like material accumulations based on said imaging data, and
performing at least one action based on the determined property.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

The presented considerations concerning the various embodiments of the apparatus may be flexibly applied to the embodiments of a method mutatis mutandis, and vice versa, as being appreciated by a skilled person.

### BRIEF DESCRIPTION OF THE DRAWINGS

Next the invention will be described in greater detail with reference to exemplary embodiments in accordance with the accompanying drawings, in which:

FIG. 1 shows a side view of at least a portion of an exemplary apparatus,

FIG. 2 shows a top view of at least a portion of an exemplary apparatus, and

FIG. 3 illustrates a flow chart of a method.

### DETAILED DESCRIPTION

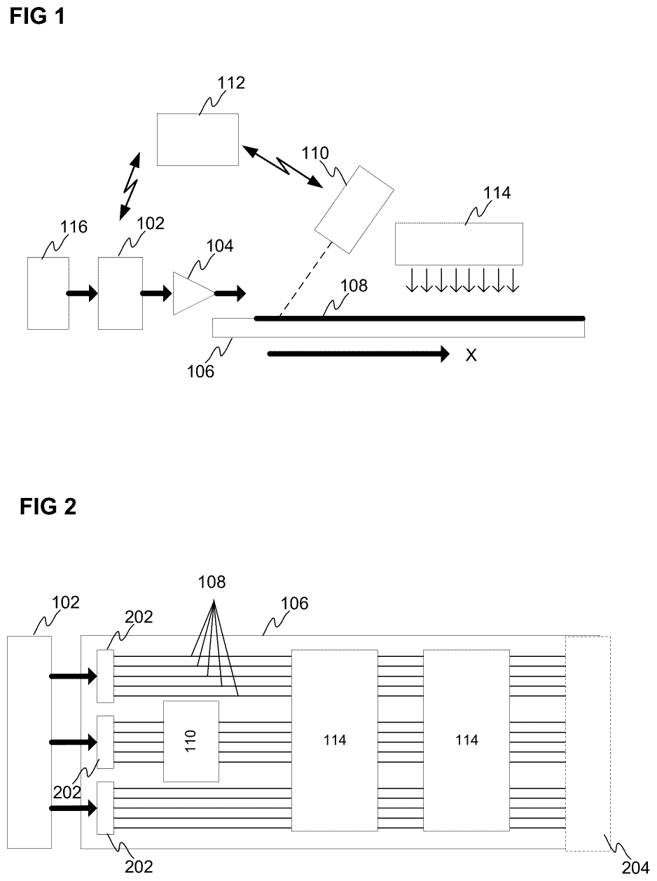

FIG. 1 schematically illustrates at least a portion of an apparatus for providing a material comprising moisture content to be dried. The apparatus comprises a material provision unit 102 that is configured to receive or provide a material comprising moisture content and direct the material comprising moisture content to a plurality of nozzles 104. FIG. 1 depicts a side view of the apparatus, from a first viewing direction that is essentially in the same plane as a machine direction X. From the side view of the apparatus of the example of FIG. 1, only one nozzle 104 may be provided along the line of sight.

The nozzles 104 may be material outputs that are configured to receive a material comprising moisture content and provide the material comprising moisture content through an orifice of selected size. The size of the orifice and the dimensions of the nozzle 104 may depend on the raw material and/or on the material that is to be produced via the process. The nozzle may e.g. be a syringe-type nozzle with an orifice comprising a micrometer-range inner diameter.

The apparatus additionally comprises at least one imaging device 110 or imaging means for obtaining imaging data and at least one control unit 112 that obtains the imaging data and is configured to facilitate performing of at least one action.

The apparatus may also comprise or be provided in connection with one or more drying units 114 that are configured to provide drying energy, such as heat, for drying the material comprising moisture content. Drying may refer to eliminating at least a portion or essentially all of the moisture content of the material comprising moisture content. The drying unit(s) 114 may be heating gas flow providing apparatuses or the drying units may additionally or alternatively locate e.g. under the drying surface 106 to directly heat the drying surface.

An apparatus may further comprise one or more mixing units 116. The mixing unit 116 may be configured to receive and mix together at least one raw material component and at least one solvent to provide the material comprising moisture content. A mixing unit may be provided as a separate entity that is configured to direct the material comprising moisture content to the one or more material provision units 102 or the mixing unit 116 and material provision unit 102 may be provided as one entity.

A mixing unit 116 may be associated with one or more mixing parameters. The mixing parameters may be related to a mixing speed or a composition of the material comprising moisture content, for instance. The composition of the material comprising moisture content may refer to which constituents are used in the material and/or in which order and/or in which amounts the constituents are utilized. A composition parameter may be related to a viscosity of the material comprising moisture content, e.g. by being associated with an amount of rheology modifier that may be received by the mixing unit and mixed with the at least one raw material and solvent.

The at least one raw component may be provided in pulp form, and may comprise e.g. at least cellulose fibrils, such as microfibrillated cellulose. Additionally or alternatively, a raw material component may for instance comprise at least one protein fiber raw material.

The present invention is particularly advantageous in connection with a process for drying material comprising at least cellulose fibrils, where the elongated string-like material accumulations are dried to form filaments, which may be further processed to form e.g. yarn. Of course, the present invention may be usable with various types of materials that are to be dried, which are provided as elongated string-like material accumulations, where the properties of the material and/or characteristics of associated nozzles are to be determined or monitored.

The material provision unit 102 may be configured to control at least one parameter relating to a manner in which the material comprising moisture content is provided to the plurality of nozzles 104. The at least one parameter may comprise a mass flow rate of the material comprising moisture content that is being provided. The mass flow rate may be a mass flow rate that is provided to a selected set of nozzles. A mass flow rate may be the same or different for different sets of nozzles.

The plurality of nozzles 104 are configured to receive the material comprising moisture content and provide the material comprising moisture content therethrough to a selected location on a drying surface 106. The drying surface 106 (or at least a portion thereof) is configured to be movable with respect to the plurality of nozzles 104. In the apparatus of FIG. 1, the drying surface 106 (or at least a selected location on the drying surface 196) is configured to be movable along a machine direction X, such that as the material comprising moisture content is provided through the nozzles 104 to the drying surface 106, a plurality of elongated string-like material accumulations 108 are formed. Each elongated string-like material accumulation 108 thus comes from and may be associated with a specific nozzle 104.

The drying surface 106 may comprise a belt, such as a conveyor belt-type element. The drying surface may alternatively comprise at least one rotating drum or cylinder, for example.

The at least one imaging device 110 of the apparatus is configured to obtain imaging data of at least one of the elongated string-like material accumulations 108. Preferably, the imaging data is obtained regarding a plurality of the elongated string-like material accumulations 108 or all of the elongated string-like material accumulations 108.

The imaging device 110 may be any type of imaging device. Devices utilizing X-ray and/or magnetic resonance imaging techniques for instance may be possible, but optical imaging devices may provide economical and/or convenient means for obtaining the imaging data. The imaging device 110 may be or comprise a camera, such as a digital photographic camera, a (digital) video camera, or line scan camera, for instance.

The type of imaging device 110 that is selected may be based on the type of imaging data that is desired and/or the type of property that is to be determined based on the imaging data. The imaging data may be obtained through the imaging device utilizing selected wavelengths of light, which may for instance be in the visible and/or infrared spectrum.

An apparatus may comprise only one imaging device 110 or an apparatus may comprise a plurality of imaging devices 110. The imaging devices 110 may be the same types of imaging devices or they may be different types of imaging devices 110, e.g. wherein different types of properties are determined via the different types of imaging data obtained.

A plurality of imaging devices 110 may also be used to collectively obtain more imaging data or more informative imaging data, e.g. a plurality of imaging devices 110 utilized per selected area may result in higher resolution of imaging data.

A plurality of imaging devices 110 may be provided at selected imaging locations, e.g. along the machine axis X. One or more properties may then be determined at different time intervals regarding the same elongated string-like material accumulation 108. For example, a property may be monitored as the material comprising moisture content is dried as it traverses along the axis X.

One preferable selected imaging location for at least one imaging device 110 may be close to the nozzles 104, such as e.g. within 1 m from the nozzles 104 in the X direction, whereby the material being outputted from the nozzles 104 may be effectively monitored.

One other selected imaging location for at least one imaging device 110 may be close to an end point of the drying surface 106, referring to a point where the dried material should be removed from the drying surface 106. It may be noted that locations of the drying surface referred to may refer to locations at a selected instant in time. An “end point of the drying surface” may thus refer to a location of the drying surface 106 (or area generally along the drying surface in a direction perpendicular to the direction X) that at a given time is positioned at a location where the material should be removed from the drying surface.

The control unit 112 may comprise at least one memory unit and one or more processing units for data processing. The control unit 112 may be a separate computing unit that is in wired or wireless connection with at least one of the other components of the apparatus or the control unit may be integrated with one or more of the other apparatus components.

The control unit 112 is configured to obtain the imaging data and determine at least one property of at least one of the elongated string-like material accumulations 108 based on the imaging data. The property may be determined for and relate to one or more elongated string-like material accumulations 108 separately, and/or the property may be determined regarding a plurality of elongated string-like material accumulations 108 as a group or set.

Various different types of properties may be determined. Only one property may be determined or a plurality of properties may be determined simultaneously. The properties may be directly derivable based on the imaging data and/or properties that are directly derivable based on the imaging data may be used to determine (further) properties or characteristics of the material comprising solvent content, a dried material, and/or relating to apparatus components or process parameters.

For example, based on the imaging data a determined property may relate to a homogeneity of at least one elongated string-like material accumulation 108 (based on e.g. brightness fluctuations of the imaging data). The homogeneity may be indicative of air bubbles present in the elongated string-like material accumulation 10. A characteristic or further property determined based on the homogeneity may then be e.g. a quality parameter relating to the elongated string-like material accumulation 108. The quality parameter may indicate, for instance, that the produced final (dried) product is of low quality if it is determined that air bubbles are present in a manner and/or quantity that exceeds a threshold level.

The determined property may for example be a dimensional parameter, a homogeneity parameter, and/or a color parameter relating to at least one elongated string-like material accumulation 108.

The determined property may be indicative of at least one dimension of at least one of the elongated string-like material accumulations 108. Here, the property may be related to an existence of a selected elongated string-like material accumulation 108 at a certain location (an imaging location) of the drying surface 106 at a certain (imaging) time and/or a number of elongated string-like material accumulations 108 present at the drying surface 106 at a certain location on the drying surface 106 and/or a continuity of at least one of the elongated string-like material accumulations 108.

A property being indicative of at least one dimension of at least one of the elongated string-like material accumulations 108 may for instance directly be a width of at least one of the elongated string-like material accumulations 108 that may be determined based on the imaging data.

A width of an elongated string-like material accumulation 108 may be under a threshold value if an associated nozzle is at least partially blocked. A width of an elongated string-like material accumulation 108 may be over a threshold value if at least one nozzle in an associated set of nozzles is at least partially blocked and at least a portion of the nozzles in the set thereby output the material comprising moisture content at a speed that is undesirably high.

A property that may be considered may be indicative of a distance between the elongated string-like material accumulations 108. The property may be utilized to determine that a nozzle 104 does not output the material comprising moisture content to a desired location.

A property being indicative of at least one dimension of at least one of the elongated string-like material accumulations 108 may additionally or alternatively comprise e.g. data relating to a number of elongated string-like material accumulations 108 present at the drying surface 106, for instance along a cross-sectional axis being essentially perpendicular to the machine axis X at an imaging location being a location from which the imaging data is obtained, preferably including information on the location of the present elongated string-like material accumulations 108 on the surface, from which it can be determined to which specific nozzles 104 the present elongated string-like material accumulations 108 have been produced. Thus, it may be possible to determine to which specific nozzle 104 a non-existing elongated string-like material accumulation 108 relates to, i.e., which location on the drying surface corresponds to a location at which an elongated string-like material accumulation 108 should be present, if the nozzle 104 is functioning as it should. A characteristic or state relating to one or more nozzles 104 that may be determined may then be indicative of blockage or non-blockage (or degree of blockage) of the nozzle 140. For determining such data, e.g. a line scan camera is sufficient. The use of high-quality cameras with high resolution is thus not necessary.

A property being indicative of at least one dimension of at least one of the elongated string-like material accumulations 108 may additionally or alternatively comprise data relating to a number of elongated string-like material accumulations 108 present at the drying surface 106, which may be used to determine that at least one elongated string-like material accumulation 108 is present at a location where it should not be. This may be the case when an imaging device 110 is utilized at or near an end point of the drying surface 106.

Based on the determined at least one property, the control unit 112 is additionally configured to facilitate performing of at least one action. The action may be related to assignment of one or more quality parameters and/or adjustment of the provision of material comprising moisture content, relating for example to adjustment of functioning of the material provision unit 102 and/or a mixing unit 116.

In one embodiment, an adjustment may be related to a difference in speed between the provision of material comprising moisture content and a speed of the moving drying surface 106. An adjustment may be an adjustment of a moving speed of the drying surface 106.

An adjustment may be related to a mixing parameter, for example based on a determined color parameter or homogeneity parameter that is determined based on the at least one determined property. In this case, the color or homogeneity may then be adjusted as desired. For example, mixing speed may be raised to obtain a more homogenous material.

An action may be related to an adjustment of a positioning of one or more of the apparatus components, such as adjustment of a positioning of a nozzle head, if the determined property indicates that e.g. two elongated string-like material accumulations 108 are too close to each other. An adjustment may also be adjustment of a distance between one or more nozzles 104 and the drying surface 106.

FIG. 2 shows a top view of at least a portion of an exemplary apparatus. Here, the material provision unit 102 delivers the material comprising moisture content to a plurality of sets 202 of nozzles 104. The separate nozzles 104 are not depicted in FIG. 2, but the figure depicts an exemplary apparatus with three sets 202 of nozzles 104, with each set 202 comprising five nozzles 104. The number of sets of nozzles and number of nozzles in each set is merely exemplary. The number of sets 202 of nozzles could be e.g. between two and tens of sets 202 and a number of nozzles 104 in each set 202 could be between a few nozzles 104 and thousands of nozzles 104, such as between 100 and 1000 nozzles 104 per set 202.

Each nozzle 104, at least when functioning properly as intended, may be configured to output material comprising moisture content to provide an elongated string-like material accumulation 108 on the drying surface 106.

FIG. 2 illustrates one imaging device 110 that is configured to preferably obtain imaging data relating to all of the string-like material accumulations 108 that are provided (at least when the apparatus is functioning as intended). As described previously, also any other number of imaging devices 110 may be utilized at any selected imaging location. FIG. 2 depicts also an end point or end area/location 204 of the drying surface 106.

The example apparatus of FIG. 2 comprises two drying units 114 located above the drying surface 106, while of course also different number and/or type of drying units may also be utilized.

A determined property may e.g. indicate that at least one set 202 of nozzles comprising a selected number of nozzles 104 outputs a number of elongated string-like material accumulations 108 that is less than the selected number of nozzles 104 comprised in the set 202 of nozzles. A number of blocked nozzles 104 may then be determined.

It may have been determined that a set 202 of nozzles 104 comprising the selected number of nozzles shall have each nozzle 104 output the material comprising moisture content at or near a reference or target exit velocity and/or that a selected mass flow rate of material comprising moisture content shall be delivered to the set of nozzles via the material provision unit 102 in a reference or starting condition, when all nozzles 104 of the set 202 are unblocked.

If the determined property indicates that at least one of the nozzles 104 in the set 202 of nozzles is at least partially blocked, this would entail that the unblocked nozzles 104 of the set 202 of nozzles output the material comprising moisture content at an exit velocity that exceeds a reference or target exit velocity. The control unit 112 may be configured to determine an adjusted (reduced) mass flow rate of material comprising moisture content that shall be delivered to the set 202 of nozzles based on the number of blocked nozzles 104, such that the remaining unblocked nozzles 104 of the set 202 of nozzles outputs the material comprising moisture content at an exit velocity that is adjusted to be at or near the reference or target exit velocity.

An action may then be that the control unit 112 causes the material provision unit 102 to change the mass flow rate of material comprising moisture content to the specific set(s) 202 of nozzles comprising one or more blocked nozzles 104 from the previously provided mass flow rate to an adjusted mass flow rate. After this adjustment, the remaining unblocked nozzles 104 in the set 202 may output the material comprising moisture content at or near the reference or target exit velocity.

An action may alternatively or additionally comprise providing a user of the apparatus with information indicating which specific nozzles 104 are at least partially blocked, such that appropriate maintenance procedures may be facilitated.

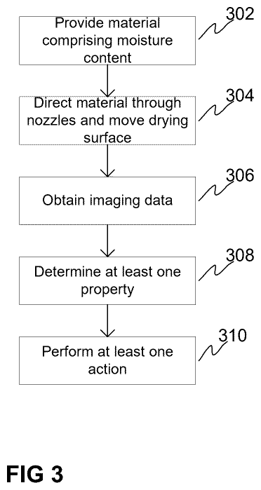

FIG. 3 shows a flow chart of a method for providing a material comprising moisture content to be dried. The method comprises providing 302 a material comprising moisture content. The providing of a material comprising moisture content may e.g. be carried out by mixing together at least one raw material component and at least one solvent.

The method further comprises directing 304 the material comprising moisture content through a plurality of nozzles 104 to a drying surface 106, and moving said drying surface 106 with respect to the plurality of nozzles 104 to obtain a plurality of elongated string-like material accumulations 108.

At 306, the method comprises obtaining imaging data relating to the plurality of elongated string-like material accumulations 108.

The method then comprises determining 308 at least one property of at least one of the elongated string-like material accumulations based on the imaging data. At least one of the properties may be indicative of dimensions of at least one of the elongated string-like material accumulations 108.

The method further comprises performing 310 at least one action based on the determined property.

The invention has been explained above with reference to the aforementioned embodiments, and several advantages of the invention have been demonstrated. It is clear that the invention is not only restricted to these embodiments, but comprises all possible embodiments within the spirit and scope of inventive thought and the following patent claims.

The features recited in dependent claims are mutually freely combinable unless otherwise explicitly stated.

1. An apparatus for providing a material comprising moisture content to be dried, the apparatus comprising at least:
a material provision unit,
a plurality of nozzles, and
a drying surface wherein said drying surface is configured to be movable with respect to the plurality of nozzles,
wherein the material provision unit is configured to receive or provide a material comprising moisture content and direct the material comprising moisture content through the plurality of nozzles to the drying surface to obtain a plurality of elongated string-like material accumulations,
wherein the apparatus additionally comprises:
at least one imaging device configured to obtain imaging data of at least one of the elongated string-like material accumulations, and
at least one control unit configured to determine at least one property of at least one of the elongated string-like material accumulations based on said imaging data, wherein the control unit is additionally configured to facilitate performing of at least one action based on the determined property.

2. The apparatus according to claim 1, wherein the apparatus additionally comprises a mixing unit configured to receive at least one raw material component, optionally cellulose fibrils, and at least one solvent, optionally water, wherein the control unit is configured to adjust a mixing parameter, such as a mixing speed, based on the determined property.

3. The apparatus according to claim 1, wherein the apparatus comprises at least one drying unit configured to provide drying energy, such as heat, to dry the material comprising moisture content.

4. The apparatus according to claim 1, wherein the control unit is configured to facilitate an action that is related to an adjustment of at least one of providing a material comprising moisture content or of directing the material comprising moisture content through a plurality of nozzles to a drying surface, optionally to alter the determined property in a selected manner.

5. The apparatus according to claim 1, wherein the control unit is configured to determine at least one property that is indicative of at least one dimension of at least one of the elongated string-like material accumulations, optionally wherein the property is utilized to determine a number of elongated string-like material accumulations that are present on the surface.

6. The apparatus according to claim 4, wherein if the control unit determines that at least one dimension relating to at least one elongated string-like material accumulation exceeds a predetermined maximum value or falls below a predetermined minimum value and/or if said property being indicative of at least one dimension indicates non-existence of at least one elongated string-like material accumulation, the control unit is configured to determine that a nozzle associated with an elongated string-like material accumulation is at least partially blocked.

7. The apparatus according to claim 6, wherein if it is determined that at least one nozzle is at least partially blocked, the control unit is configured to facilitate an action comprising adjusting a mass flow rate or volume flow rate of the material comprising moisture content being provided to the plurality of nozzles via the material provision unit, preferably by reducing a mass flow rate or volume flow rate of the material comprising moisture content by a selected amount based on data indicating nozzles that are at least partially blocked to achieve or approach a reduced exit velocity of material from unblocked nozzles.

8. The apparatus according to claim 7, wherein the material provision unit is configured to provide the material comprising moisture content through at least one set of nozzles comprising a selected number of nozzles, with material comprising moisture content being provided to at least one set of a selected number of nozzles at selected mass flow rate or volume flow rate, and wherein the control unit is configured to:
obtain or determine a reference exit velocity of material comprising moisture content from one nozzle of said at least one set of nozzles comprising a selected number of nozzles,
determine a number of nozzles in said at least one set of a selected number of nozzles that is at least partially blocked based on said imaging data, and
adjust a mass flow rate or volume flow rate of material comprising moisture content being provided to said at least one set of a selected number of nozzles to achieve or at least approach the reference exit velocity of material comprising moisture content from the remaining nozzles of the at least one set of a selected number of nozzles.

9. The apparatus according to claim 1, wherein the imaging device comprises at least one optical instrument imaging device configured to obtain at least one image, optionally at least one camera, such as a photographic camera, a line scan camera, and/or a video camera.

10. The apparatus according to claim 1, wherein imaging device is configured to obtain a plurality of images, and wherein the control unit is configured to essentially continuously monitor the at least one determined property.

11. The apparatus according to claim 1, wherein the control unit is configured to determine a plurality of different properties essentially simultaneously.

12. The apparatus according to claim 1, wherein the control unit is configured to determine at least one quality parameter relating to the at least one elongated string-like material accumulation based on said at least one determined property and wherein said at least one action comprises assigning at least a portion of the provided material comprising moisture content to be dried with at least one quality grade according to predetermined criteria.

13. The apparatus according to claim 1, wherein the control unit is configured to determine a property comprising a color parameter of the material comprising moisture content or a homogeneity parameter of the material comprising moisture content.

14. A method for providing a material comprising moisture content to be dried, the method comprising
providing a material comprising moisture content,
directing the material comprising moisture content through a plurality of nozzles to a drying surface, and moving said drying surface with respect to the plurality of nozzles to obtain a plurality of elongated string-like material accumulations,
obtaining imaging data relating to the plurality of elongated string-like material accumulations,
determining at least one property of at least one of the elongated string-like material accumulations based on said imaging data, and
performing at least one action based on the determined property.
